(19) United States
(12) Patent Application Publication
(10) Pub. No.: US 2014/0094275 A1
(43) Pub. Date: Apr. 3, 2014

(54) Sharable Games Created by Others

(71) Applicant: WMS GAMING, INC., Waukegan, IL (US)

(72) Inventors: Thomas Abouchar, Atlanta, GA (US); Michael Dicillo, Chicago, IL (US); Andrew Christian Guinn, Chicago, IL (US)

(73) Assignee: WMS GAMING, INC., Waukegan, IL (US)

(21) Appl. No.: 13/776,821

(22) Filed: Feb. 26, 2013

Related U.S. Application Data
(60) Provisional application No. 61/706,939, filed on Sep. 28, 2012.

(51) Int. Cl. G07F 17/32

(52) U.S. Cl. CPC G07F 17/3272
USPC 463/25

(57) ABSTRACT

A system and method for providing a virtual customized wagering game include providing a customization interface to a first player to allow the first player to customize a virtual wagering game to create a customized virtual wagering game. The customized virtual wagering game created by the first player is stored and is provided to one or more other players alone or as part of a casino created by the first player. The one or more other players are able to play the customized virtual wagering game, and in an embodiment such play may confer a benefit such as an amount of virtual currency or a customization feature on the first player.

### COPYRIGHT

A portion of the disclosure of this patent document may contain material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD OF THE DISCLOSURE

The present disclosure relates to wagering games and gaming systems and, more particularly, relates to the generation and use of sharable wagering games created by a first player and played by other players.

### BACKGROUND OF THE DISCLOSURE

Wagering games such as slot machine games, video poker games and the like, have been important aspects of the gaming industry for some time. Generally, the popularity of such games, and thus the profitability and effectiveness of such games, depends on the “odds” that the game provides, i.e., the likelihood of winning as well as the intrinsic entertainment value of the game relative to other available gaming options. In general, where the odds are relatively consistent across games, players are attracted to the most entertaining and exciting games. As such, operators strive to employ the most entertaining and exciting games, features, and enhancements available to attract frequent play and increase profitability to the operator.

Therefore, there is a continuing need for wagering game providers to continuously develop new games and gaming enhancements that will attract frequent play. The present disclosure is directed primarily to a system and method that address one or more of the needs set forth above. However, it should be appreciated that the solution of any particular problem is not a limitation on the scope of this disclosure nor of the attached claims except to the extent expressly noted. Additionally, the inclusion of any problem or solution in this Background section is not an indication that the problem or solution represents known prior art except as otherwise expressly noted.

### SUMMARY OF THE DISCLOSURE

In accordance with one aspect of the present disclosure, a computer-implemented method is provided. The computer-implemented method includes providing, by at least one of one or more processors, a customization interface to a first player, the customization interface permitting the first player to create a customized virtual wagering game. The customized virtual wagering game created by the first player is stored in one or more memory devices, and one or more other players are enabled by at least one of the one or more processors to access the stored customized virtual wagering game to permit the one or more other players to play the customized virtual wagering game.

In accordance with another aspect of the present disclosure, a non-transitory computer-readable medium is provided having stored thereon computer-executable instructions for an operator to provide a customized virtual wagering game to a plurality of players. The computer-executable instructions include instructions for providing a base version of the customized virtual wagering game to a first player and for receiving an indication of one or more desired alterations to the base version of the customized virtual wagering game from the first player through a customization interface. The instructions further include instructions for creating the customized virtual wagering game by altering the base version of the customized virtual wagering game in accordance with the one or more desired alterations and for storing the customized virtual wagering game. Finally, the instructions also include instructions for providing the customized virtual wagering game to players other than the first player to permit them to play the customized virtual wagering game.

In accordance with yet another aspect of the present disclosure, a system is disclosed for an operator to provide a customized wagering game to a plurality of players. The system includes an operator server configured to provide a customization interface to a first player permitting the first player to create the customized wagering game, the operator server being further configured to store the customized wagering game and to provide the customized wagering game to a plurality of other players.

Other features and advantages of the disclosed systems and principles will become apparent from reading the following detailed disclosure in conjunction with the included drawing figures.

### BRIEF DESCRIPTION OF THE DRAWINGS

FIG. 1 is a system schematic showing a network architecture in accordance with an aspect of the disclosed principles;

FIG. 2 is a system schematic showing a network architecture in accordance with an alternative aspect of the disclosed principles;

FIG. 3 is a user interface diagram showing an example user interface usable in an embodiment;

FIG. 4 is a user interface diagram in accordance with the example user interface of FIG. 3 with certain customization options selected;

FIG. 5 is a user interface diagram in accordance with the example user interface of FIG. 3 with certain other customization options selected;

FIG. 6 is a user interface diagram in accordance with the example user interface of FIG. 3 with further customization options selected;

FIG. 7 is a user interface diagram in accordance with the example user interface of FIG. 3 with yet further customization options selected;

FIG. 8 is a flow chart showing a process of creating, providing, and using a customized game in accordance with certain aspects of the disclosure;

FIG. 9 is a schematic view of an exemplary casino customization interface in accordance with an embodiment of the disclosed principles; and

FIG. 10 is a schematic view of a casino board exposing a plurality of casino options in accordance with the described principles.

### DETAILED DESCRIPTION OF THE DISCLOSURE

The present disclosure provides a system and method for enabling slot machine players to create customized slot games that can then be played by other players. For example, a first player may create a virtual casino having one or more customized slot machines for play by other players. As other players play the first player's games, the first player may accrue points or virtual currency for use to create further enhancements to their games, their casinos, and the like.

In an embodiment, the first player may customize a virtual slot machine by selecting from various options in a suitable graphical user interface (GUI). For example, the first player may be able to select the number of reels that the game will have, and/or the symbols to be used on the reels. In an embodiment, a menu of graphics may be provided to the first player for this purpose. Further, the first player may select, in an embodiment, the number of symbols to be hosted on each reel. In addition to functional aspects such as those described above and others, the first player may also be given the option to add or modify ornamental aspects of the machine such as machine art. Moreover, the first player may also be provided an option to customize their virtual casino, e.g., to add curtains, lighting, and so on.

In an embodiment, additional enhancements may be made available for payment. While any enhancement may be either a free or a for-pay enhancement depending upon operator preference, in an embodiment, additional for-pay enhancements include adding a bonus game, adding various sounds, graphics, or animations, and adding additional lines of play. For example, instead of having a single line, the first player may pay to have three lines and to thus create a more attractive and potentially popular game. Other enhancements include but are not limited to backgrounds, advanced game options (e.g., a progressive option), winning triggers, transitions to other games, and so on.

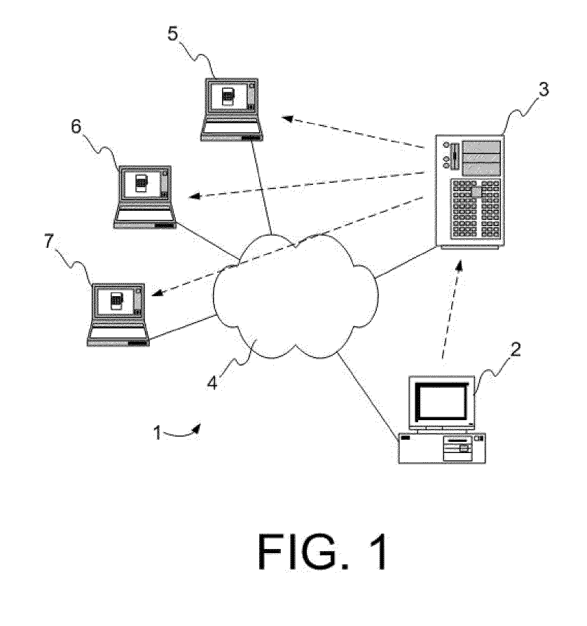

Turning to FIG. 1, there is shown a basic system schematic of a network architecture 1 in accordance with an aspect of the disclosed principles. The illustrated embodiment includes a first player computer 2 usable by the first player to create a customized game. An operator server 3 is communicatively linked to the first player computer via a network 4. The network 4 may be any network or combination of network connections, including the Internet, a LAN, a WiFi network, a WAN, and so on. For example, the first player computer 2 may be wirelessly linked to the Internet via a home WiFi connection, and the operator server 3 may be linked to the Internet via a hard-wired connection.

The illustrated example network architecture 1 further includes a second player computer 5 to allow a second player to play the game created by the first player via the first player computer 2. The second player computer is linked to the operator server 3 via the same network 4 or a different network. It will be appreciated that, as with the first player computer 2, the second player computer 5 may be linked to the operator server 3 via one or more type and number of network connections.

In addition to the first player computer 2 and the second player computer 5, the illustrated example network architecture 1 further includes a third player computer 6 and a fourth player computer 7. The third player computer 6 and the fourth player computer 7 are used in an embodiment by additional users to play the game created by the first player via the first player computer 2. Aside from hardware limitations that may be present in a given implementation, there is no requirement or limit on the number of players that may play the game created by the first player.

In operation, the first player may create a customized game at the first player computer 2 in cooperation with the operator server 3. The operator server 3 may for example present a web interface to the first player computer 2 whereby the first player is able to enter user data, purchase virtual currency, and manipulate on-screen graphics and options to create the desired customized game. As noted above, the user may select game mechanics, graphics, and options as well as background and environmental items, with some selections requiring payment while a basic set of selections may be available free of charge.

The customized game thus created is stored, in an embodiment, on the operator server 3 for use by the first player or other players. Thus, for example, a player at the second player computer 5 may access the stored customized game of the first player and may play it for points, for virtual currency, for leader board status, and so on.

The manner in which the second player becomes aware of the customized game is not critical, but there are several example modes of notification that will be discussed. One mode of notification is via publication on the first player's social network page, e.g., via a FACEBOOK page or other social network page.

Another mode of notification is via an invite to the second player from the first player; for example, a social network ping or invitation may be sent from the first player to one or more other individuals who may be interested in playing the customized game created by the first player. Another mode of notification is via publication of a link to the game, e.g., via a URL, QR code, near field communication (NFC) tag, and so on.

In an embodiment, the first player may notify others of their virtual casino rather than of a specific game. In this embodiment, visitors to the virtual casino may become aware of the customized game via their visit.

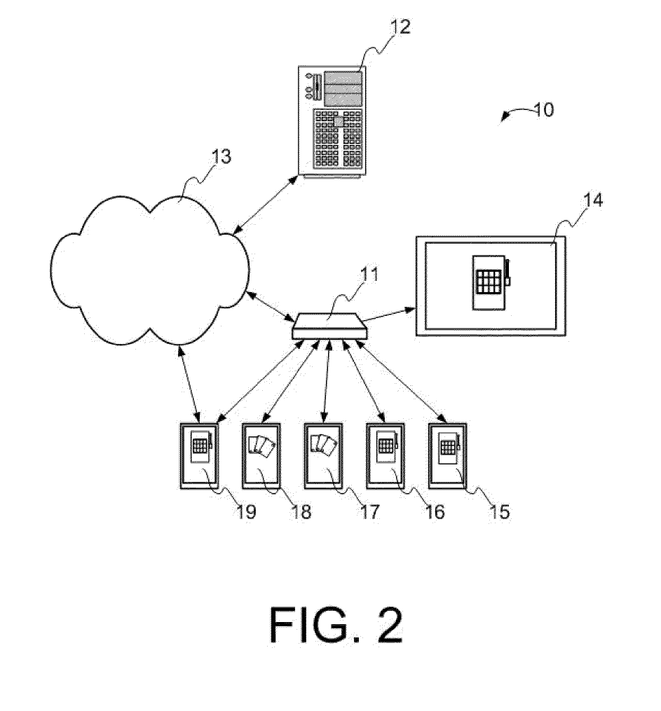

In an alternative embodiment, the customized game may be made available in an in-home setting via a console for example. An exemplary in-home architecture 10 in keeping with this embodiment is shown in FIG. 2. The illustrated exemplary in-home architecture 10 includes a console or set-top box 11. In an embodiment, the set-top box 11 is a device embodying both communications and processing capabilities.

The set-top box 11 is communicatively linked to an operator server 12 via a network 13. The network 13 may be any suitable network connection or set of network links including wireless and/or wired links. In an embodiment, the network 13 is or includes the Internet, and may also include LAN, WiFi, WAN, LAN or other suitable links.

In an embodiment, the set-top box 11 is also communicatively linked, via a wired or wireless link, to a display device 14. The display device 14 may be a television, computer monitor or other suitable device able to receive an image signal and provide a corresponding display to the user. In an embodiment, the display device is a flat screen television.

In an aspect of the illustrated exemplary in-home architecture 10, one or more mobile devices 15, 16, 17, 18, 19 are used in conjunction with the set-top box 11. The one or more mobile devices 15, 16, 17, 18, 19 may be of the same or different types, and may be characterized in that they are able to wirelessly communicate with the set-top box 11. Devices potentially usable as one of the one or more mobile devices 15, 16, 17, 18, 19 include cell phones generally, IPHONEs, IPODs, ANDROID devices and so on.

In operation a first player may create a customized slot game via the set-top box 11 or via a separate computer, not shown in FIG. 2, as described with respect to FIG. 1. In the event that the user employs the set-top box 11 to create the customized slot game, the first player may employ one of the one or more mobile devices 15, 16, 17, 18, 19 to provide input to the set-top box 11. In addition, the user may utilize a graphical user interface provided on the one of the one or more mobile devices 15, 16, 17, 18, 19, or alternatively may utilize a graphical user interface provided on the display device 14, e.g., a television, computer monitor or other suitable device.

As the first player creates the customized slot game, the set-top box 11, which is communicatively linked to the operator server 12, updates the first player's account on the operator server 12 to reflect the game being created. As noted above, the first player may select among free and paid options for customizing the game, with payment for the paid options being made to the operator hosting the operator server 12.

Once the first player has created the customized slot game and the game has been stored on the operator server 12, the first player is able to allow others to play the game thus created. In the illustrated exemplary in-home architecture 10, the others interact with and play the customized slot game via the one or more mobile devices 15, 16, 17, 18, 19 (other than the device, if any, being used by the first player).

In an embodiment, each other player is able to play the customized slot game on their respective one of the one or more mobile devices 15, 16, 17, 18, 19. In this embodiment, the display of the relevant device is used by the player to view and interact with the game, the game being downloaded from or hosted by or through the set-top box 11. In an alternative embodiment, at least one mobile device 19 of the one or more mobile devices 15, 16, 17, 18, 19 used by the other player or players may be communicatively linked to the operator server 12 directly via the network 13 in addition to or rather than through the set-top box 11.

In a further embodiment, each other player may interact with the customized slot game via the display device 14. In this embodiment, the customized slot game may be displayed on the display device 14, and each other player may direct their play via their respective one of the one or more mobile devices 15, 16, 17, 18, 19 in conjunction with the set-top box 11.

In yet a further embodiment, one or more of the other players may play the customized slot game on their respective one of the one or more mobile devices 15, 16, 17, 18, 19 while periodically interacting with another game or another instance of the same game via the display device 14. When a number of other players are present, this allows the opportunity to play a shared or common game via the display device 14 while playing individual games on the one or more mobile devices 15, 16, 17, 18, 19.

It will be appreciated that a customized slot game made by a first player may be made available to other players in both the manner shown and described by reference to FIG. 1 as well as in the manner shown and described by reference to FIG. 2. As such, as the other players play the customized slot game in the context of the illustrated exemplary in-home architecture 10, one or more leader boards or scoreboards may display player status relative to the one or more other users of the one or more mobile devices 15, 16, 17, 18, 19 or may display a general leader board or scoreboard relating to all players of the customized slot game. In an embodiment, both types of leader boards or scoreboards may be displayed, e.g., via the display device 14 or via the respective displays of the one or more mobile devices 15, 16, 17, 18, 19.

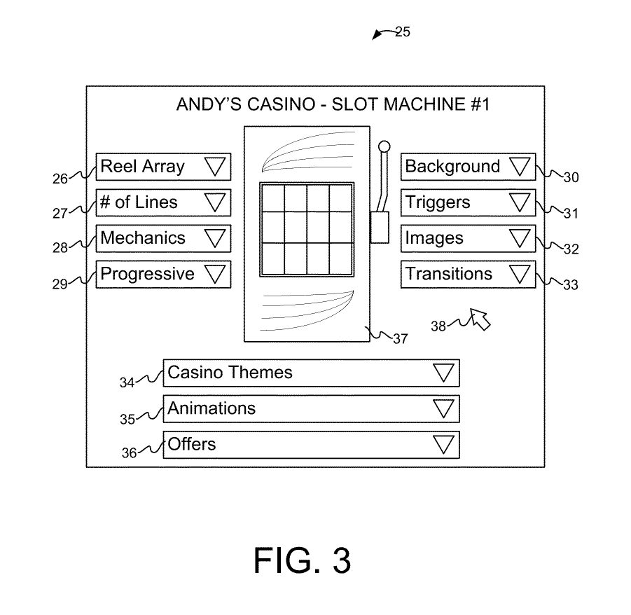

As noted above, in the embodiment described with respect to FIG. 1 and in the embodiment described with respect to FIG. 2, the first player may create a customized slot game by interacting with a graphical user interface to select free and paid options for customization. An exemplary user interface 25 is illustrated in FIG. 3, showing user-selectable options for customization. The slot machine without any optional alterations can be considered a base version of the game. It will be appreciated that the illustrated exemplary user interface 25 is given as an example only and that a user interface may be differently configured and may display the same or different options for customization without departing from the described general principles.

In the illustrated embodiment, the exemplary user interface 25 includes a number of selectable options including a selectable reel array option 26, a selectable number of lines option 27, a selectable game mechanics option 28 and a selectable special feature option 29 such as whether the game is to be progressive or not. Other options presented in the illustrated exemplary user interface 25 include a selectable background option 30, a selectable triggers option 31, e.g., to select what results will trigger a win, a selectable images option 32, e.g., to select images to present on the reel, and a selectable transitions option 33, e.g., to select graphics or animations for transitioning to or from the game.

In addition to the aforementioned selectable options, other selectable options may be included as well. For example, the illustrated exemplary user interface 25 further includes a casino themes selectable option 34, allowing the user to select curtains and other surroundings for the casino generally, as opposed to just for the game being configured at the moment. In a further embodiment, a selectable animations option 35 allows the user to select animations for use during game play, e.g., animated reel art or face art on the virtual machine 37.

In a further embodiment, a selectable offers option 36 allows the user to provide certain offers to other players who may play the created slot machine game. For example, other players may use virtual currency to purchase features for their own slot machine games or casinos that they may customize in the same manner that the first player has customized his or her virtual machine 37 or casino.

The manner of user selection is not critical. However, in an embodiment, the selectable options are pull-down menus that the first player may select via a cursor 38. The cursor may be a mouse-driven cursor, a pointer-driven cursor, or otherwise depending upon user preference and/or implementation.

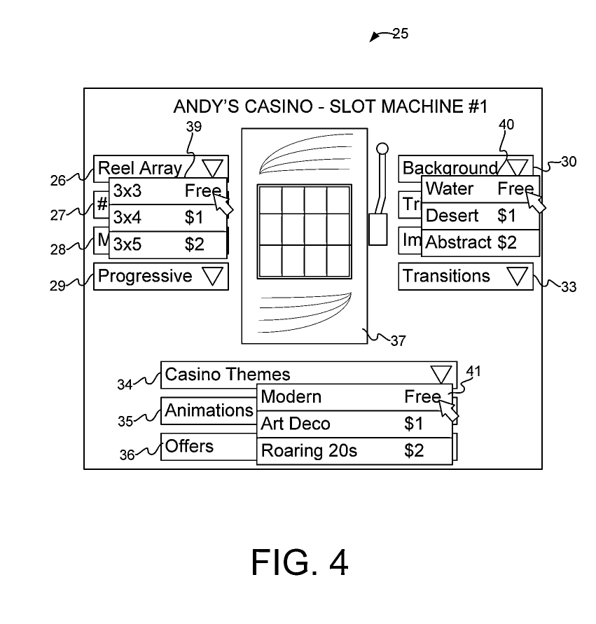

The manner in which certain values within selectable options are free while others are offered at a cost is shown in FIG. 4. In particular, the user is shown having selected several different selectable options. It will be appreciated that in practice a user would typically select a single selectable option at any given time, but that several such options are shown selected for the sake of concise description.

Upon user selection of the selectable reel array option 26, a drop down menu 39 appears giving several options for the reel array. The first of these, a 3×3 array, is offered for free. The second and third options, namely a 3×4 or 3×5 array, are offered for $1 and $2 respectively. The user may drag the cursor down the expanded list of options and either click or release on a value, depending upon implementation preference, to select that value. Thus, if the user were to drag the cursor to the 3×5 value, a confirmation and payment screen may be brought up to complete the selection and transaction.

Similarly, if the user selects the selectable background option 30, a drop down menu 40 may appear guiding the user to choose one of various selectable values. In the illustrated embodiment, the various selectable values of the drop down menu 40 include a water background at no cost, as well as desert and abstract backgrounds at costs of $1 and $2 respectively.

Also shown expanded in the illustrated embodiment is the selectable casino themes option 34. Selection of this option may reveal a drop down menu 41 of selectable casino theme values such as “modern,” “art deco,” and “roaring 20s.” As with the other selectable options and values there under, some casino theme selectable values may be offered at no cost while others may be offered at a price that may reflect the uniqueness or desirability of the value. In the illustrated example, the modern theme is offered at no cost while the art deco and roaring 20s casino themes are offered at $1 and $2 respectively.

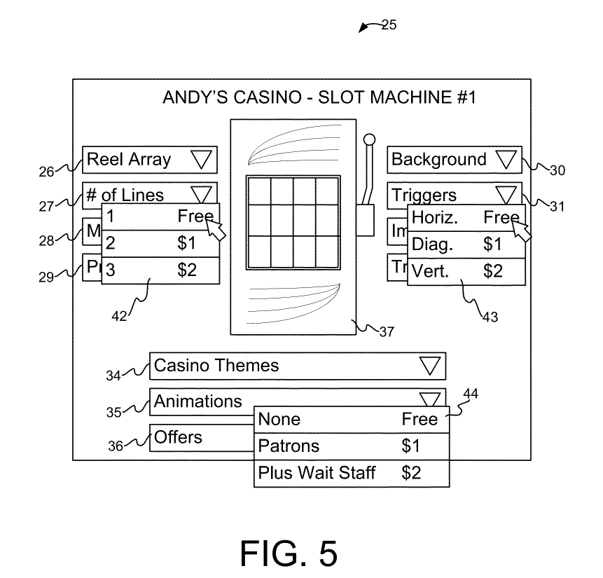

Turning to FIG. 5, an alternative group of selectable options is shown expanded. As noted above, in practice a user would typically select a single selectable option at any given time. However, several such options are shown selected in the illustrated embodiment for the sake of concise description.

In FIG. 5, the selectable number of lines option 27 has been selected, resulting in the display of a pull-down menu 42 of selectable line values. As can be seen, the selectable values include a single line, two lines, and three lines, with the single line being offered as a free default. The value of two lines is offered at a cost of $1 while the value of three lines is offered at a cost of $2.

In addition to the selectable number of lines option 27, the selectable triggers option 31 is also shown selected, resulting in the display of a pull-down menu 43 of selectable values. In the illustrated embodiment, the selectable values for triggers include a free default value of “horizontal” as well as options for “diagonal” and “vertical” at a cost. In the example, the option for a diagonal trigger is offered at a cost of $1 while the option for a vertical trigger is offered at a cost of $2.

Also shown selected in the example of FIG. 5 is the selectable animations option 35. The selection of the selectable animations option 35 has resulted in the display of a pull-down menu 44 of animation values including “none,” “patrons,” and “plus wait staff.” Although the content of any particular animation is not critical, in the illustrated example, the “patrons” option may display animations of casino patrons while the “plus wait staff” option may add wait staff animations to the patron animations. As can be seen, the “patrons” and “plus wait staff” values are selectable for $1 and $2 respectively.

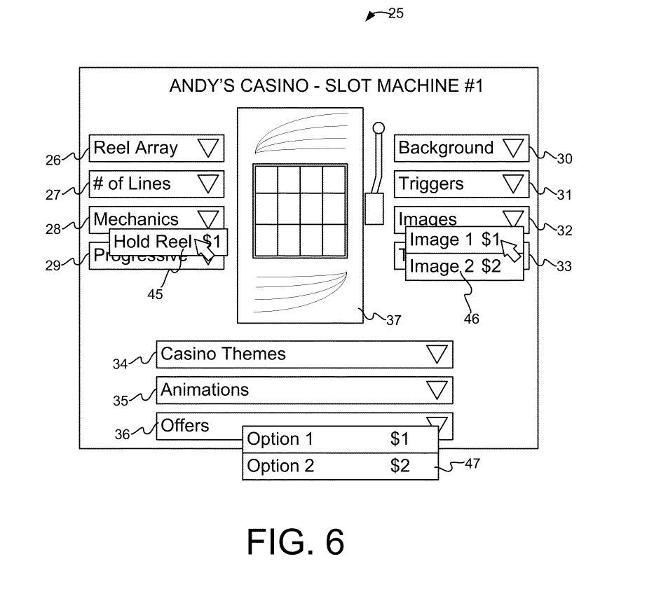

If the user selects the selectable mechanics option 28, a list of game mechanics options may be displayed in a pull-down menu 45. In the embodiment illustrated in FIG. 6, the pull-down menu 45 contains a single item, namely a hold reel value selectable for $1. Similarly, selection of the selectable images option 32 may yield a pull-down menu 46 containing a list of selectable image values. In the illustrated example, the selectable image values include “image 1” for $1 and “image 2” for $2, the selection of which may result in the selected image being displayed on the face of the virtual slot machine 37 in an embodiment.

As noted above, in an embodiment, a selectable offers option may be presented to the user to allow the user to offer certain incentives to players of the user's customized virtual slot machine game. For example, an offer may be purchasable by the user customizing the game to allow other players of the game to earn features for their own customized games, i.e., hold reel, stacked wilds, and so on. In the illustrated example, such values are illustrated generically in the pull-down menu 47 as option 1 for $1 and option 2 for $2.

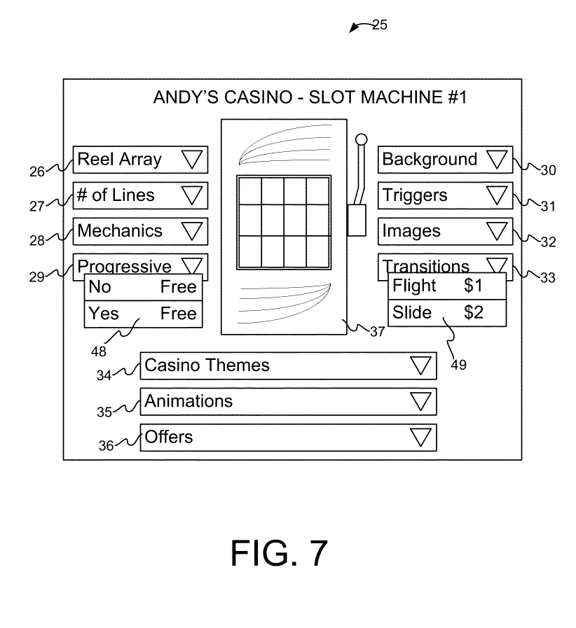

Turning to FIG. 7, this figure illustrates the user interface 25 wherein the selectable progressive option 29 has been selected. In the illustrated embodiment, selection of this option yields a pull-down menu 48 of selectable values. As shown, possible values for the selectable progressive option 29 include “no” (game will not have progressive jackpot) and “yes” (game will have progressive jackpot). Although both values are selectable for free in the illustrated embodiment, it will be appreciated that the progressive jackpot option may be offered at a cost depending upon implementation preferences.

Also shown selected in FIG. 7 is the selectable transitions option 33. In the illustrated embodiment, selection of this option results in the display of a pull-down menu 49 of selectable values. Although the effect and content of the selectable values may vary widely depending upon implementation preferences, in the example embodiment shown in FIG. 7, the pull-down menu 49 includes a slide value for $1 and a flight value for $2. In this embodiment, the transition value determines the transition animation shown to the player during transitions to and/or from the customized game.

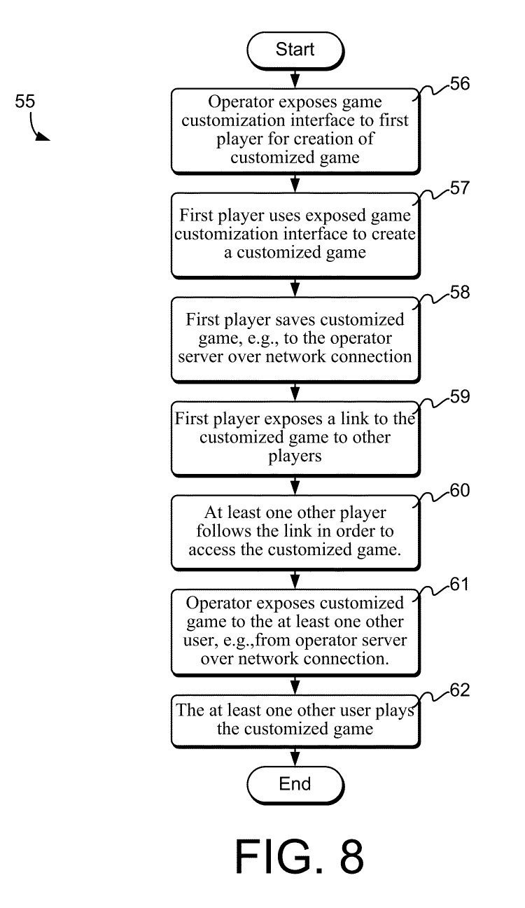

As described above, the first player customizes a virtual slot machine game offered by an operator, with some customizations being available for free and some customization being available at a cost. The first player then makes the customized virtual slot machine game available to other players via the operator, e.g., via a server hosted by the operator. The process of customization and play is described in further detail with reference to FIG. 8. In particular, FIG. 8 shows a flowchart of a process 55 for a first player creating and distributing a customized virtual slot machine game.

At stage 56 of the process 55, the operator exposes a game customization interface to the first player for creation of a customized game. The game may be a virtual slot machine game as described above or may another type of game. In an embodiment, the operator exposes the game customization interface to the first player via a network connection to an operator-hosted server. The game customization interface may be, but need not be, as illustrated in FIGS. 3-7. Depending upon the game type being customized and the options to be made available, the interface may be different than that shown in FIGS. 3-7.

The first player, using the exposed game customization interface, proceeds to create a customized game at stage 57. Subsequently at stage 58, the first player saves the customized game, e.g., to the operator server over the network connection.

With the customized game saved, the first player may expose a link to the game to other players at stage 59. As noted above, the link provides a way for other players to access and play the customized game. Thus, the link may be a URL, QR code, NFC tag, key word combination and so on and may be exposed via social media publication, a social media invitation, etc.

At stage 60, at least one other player follows the link in order to access the customized game. Thus, for example, the at least one other player may click on a URL that provides a link to the customized game. In response, the operator exposes the customized game to the at least one other user at stage 61, e.g., by transmission from the operator server over a network connection. At stage 62, the at least one other user plays the customized game.

While the foregoing examples discuss the manner in which other players may obtain features, either free or for payment, it will be appreciated that other mechanisms for obtaining features may be provided. For example, a player may earn or unlock a feature by meeting a certain set of requirements relative to the playing of other players' games.

By way of example, consider a feature of cascading reels that is currently locked for a particular player. In an example embodiment, the player may be offered the option to either purchase that mechanic for $2.00, or to obtain the mechanic through play. For example, the feature may be unlockable when the player wagers 100 virtual credits on 5 different and unique cascading games that other people have created, or wins an amount that is over a particular threshold at one given time.

In an embodiment, certain elements may not be purchasable at all, but are only obtainable via play. For example, the player may be required to fulfill a set number of requirements to unlock particular elements. As one specific nonlimiting example, a player may wish to acquire an entire thematic suite in order to quickly skin an entire game that they are creating instead of acquiring individual skinnable elements to build the game. In order to unlock that graphic suite, a player may be required to fulfill a number of play actions including, for example: playing 5 unique themes; achieving ten 5-of-a-kind combinations; winning 5 hands of video poker; and obtaining 3 “blackjacks.” In a further embodiment, players collect points by executing play actions such as those described above or others. In this embodiment, certain mechanics or other features may be obtainable or unlockable by redeeming a certain number of points, such that points are usable for different enhancements depending upon user preference.

As noted above, a first player who creates a customized game may expose that game to other players so that the other players may play the customized game. In an embodiment, the first player exposes a plurality of such games via an online virtual casino created by the first player. The first player may customize their casino both with respect to the games offered therein as well as the casino itself, e.g., the background, any animations such as patrons and wait staff, and sounds such as music, game play, etc.

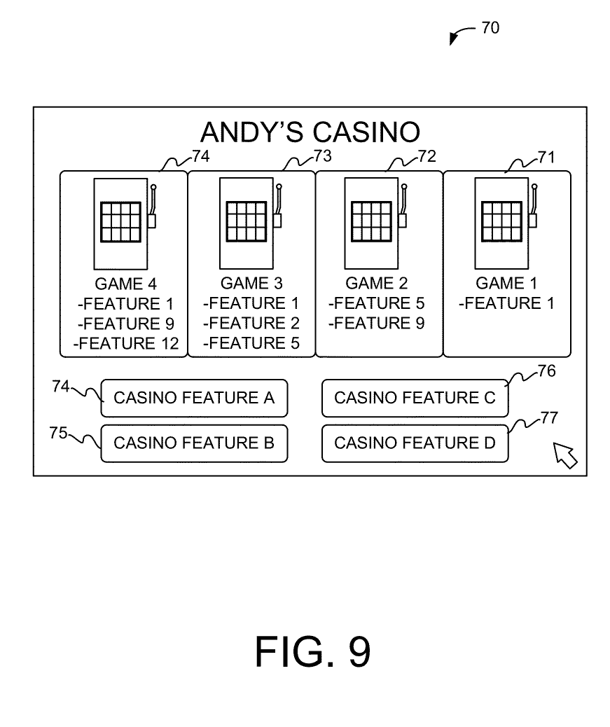

The interface for customizing a casino may be much the same as the interface for customizing individual games, and in an embodiment, as described above, the interface for customizing individual games may also include options for customizing the player's casino. An exemplary casino customization interface 70 is shown schematically in FIG. 9. In the illustrated embodiment, the casino customization interface 70 for the first player includes a representation of each game that has been created by the first player. Thus, in the example shown, the casino customization interface 70 includes a first selectable icon 71 for a game 1, a second selectable icon 72 for a game 2, a third selectable icon 73 for a game 3, and a fourth selectable icon 74 for a game 4.

Each individual game icon is selectable to yield a game customization interface such as that shown, for example, in FIGS. 3-7. Thus, from within the casino customization interface 70, the first player may customize individual games. Each selectable game icon includes a list of features associated with that game. In this way, the player can quickly see which games meet certain criteria, e.g., which games support a certain feature required to be played by other players to get a certain upgrade, etc.

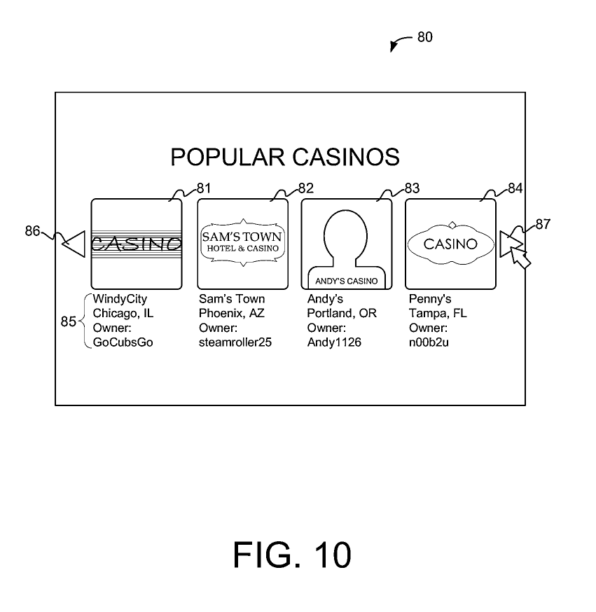

In addition, the first player may customize the casino itself from the casino customization interface 70. In the illustrated example, available casino features are exposed to the first player via selectable casino feature icons 74, 75, 76, 77 in the casino customization interface 70. The available features may include, as discussed above, background visual features and animations such as curtains, lighting, wait staff, patrons, and so on, and background audio features such as wait staff sounds, game play sounds, music etc. As with individual game customization options, some casino customization options may be free while others may require payment and/or may need to be earned by the first player through play of others customized games. In an embodiment, certain customization features allow for customization of the casino icon appearance as displayed on a popular casinos board or display as discussed with respect to FIG. 10.

Once the first player has finished customizing his or her online casino, the customized casino may be exposed to other players via a number of routes including a URL, QR code, NFC tag and so on as discussed above with respect to individual games. In addition, in an embodiment, one or more customized casinos may be exposed by the operator, e.g., via a “popular casinos” board or the like as shown in FIG. 10.

In the illustrated embodiment, the popular casinos board 80 includes a selectable casino icon for each displayed casino option, such that in the view shown, there is a first selectable icon 81 for the WindyCity Casino, a second selectable icon 82 for the Sam's Town Casino, a third selectable icon 83 for Andy's Casino, and a fourth selectable icon 84 for Penny's Casino. Each icon 81, 82, 83, 84 may have associated therewith a data field 85 conveying, for example, the casino name, location, and owner's identification.

In an embodiment, selectable navigation icons may be available to allow the user to see other casino options. In the illustrated example, the selectable navigation icons include arrows 86, 87 at each end of the row of casino icons 81, 82, 83, 84 to allow the user to scan forward or backward to other casino icons.

When a player selects one of the selectable casino icons 81, 82, 83, 84, the associated casino is displayed to the player. In an embodiment, the casino appears as in the casino customization interface 70 with respect to the information fields 75 and the representation of each game that has been created by the first player. If the casino has been customized, the customizations will also be displayed or played to the player. By then selecting a game, the player is able to play that game in accordance with any rules or restrictions that apply generally or to the selected game.

In an embodiment, a player that has created a customized wagering game may earn a benefit such as a customization feature or an amount of virtual currency by having other players play the customized wagering game, whether as part of a casino or otherwise. Thus, for example, a player may successively expand their casino and/or enhance their games as the amount of play on their customized games by other players increases. Such benefits may be tied to the number of rounds of play by the other players, the amount wagered and/or won by the other players, or any other desired metric of play by the other players. The ability for the user to redeem such benefits may be provided in the customization interface or otherwise.

While the examples herein have referenced the creation of a customized virtual slot machine game and casinos having such, the teachings herein are not limited to this example, and pertain more generally to the creation of customized wagering games generally. Thus, for example, the first player may create a customized virtual poker game, a customized virtual blackjack game, a customized virtual roulette game, a customized virtual craps game, and so on without limitation. In general, for games that may be virtualized, the described principles allow the creation of a customized version of the game for the first player to provide to other players to play.

While the payment system for the creation and play of the customized wagering game is not critical, it will be appreciated that payments may be made and received in virtual currency rather than actual currency if desired and/or if required by law. Thus, for example, payment by the first player to the operator for an optional feature in their customized wagering game may be made via virtual currency. Similar, as other players play and win the customized wagering game, their winnings may accrue in virtual currency rather than actual currency. A user may pay the operator an amount of actual currency to acquire a corresponding amount of virtual currency for use in creating customized wagering games. Similarly, a player may pay actual currency to the operator to allow play of the customized game beyond a certain base of play, e.g., a certain limited number of plays.

Moreover, although the described examples involve play of the customized wagering games via mobile devices and user computers, it will be appreciated that the customized game may be played on an operator machine as well. For example, the customized wagering game may be played on an operator console at a casino in an embodiment.

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

The computerized operations of the operator server and other computer devices described herein are executed by the computerized execution of computer-executable instructions read from a non-transitory computer-readable medium such as an optical or magnetic disc, RAM, ROM, flash memory, thumb drive, and so on. It will be appreciated that the operator server includes one or more processors for executing the server-related steps of the methods described herein. Through the use of further hardware and/or software as will be appreciated by those of skill in the art, the operator server is configured to execute the described server-related steps. This execution of steps is computer-implemented via the server and is thus referred to herein as a computer-implemented method. In general, computer-executable instructions may be used to configure the operator server to perform a given action, including the steps described herein as executed by the operator server.

Moreover, the operator server includes or is associated with one or more memory devices. In addition to storing computer-executable instructions as discussed above, such memory devices may also be employed to store customized games created by a player. In this way, the customized games may be later retrieved from memory under control of the one or more processors and provided to other players.

It will be appreciated that the present disclosure provides a system and method for a gaming enhancement whereby customized online wagering games may be user-created and shared. While only certain embodiments have been set forth, alternatives and modifications will be apparent from the above description to those skilled in the art. These and other alternatives are considered equivalents and within the spirit and scope of this disclosure and the appended claims.

What is claimed is:

1. A computer-implemented method comprising:
providing, by at least one of one or more processors, a customization interface to a first player, the customization interface permitting the first player to create a customized virtual wagering game;
storing, in one or more memory devices, the customized virtual wagering game created by the first player; and
enabling, by at least one of the one or more processors, one or more other players to access the stored customized virtual wagering game to permit the one or more other players to play the customized virtual wagering game.

2. The computer-implemented method in accordance with claim 1, wherein enabling, by at least one of the one or more processors, one or more other players to access the stored customized virtual wagering game comprises enabling access to the stored customized virtual wagering game via a link comprising at least one of a URL, a QR code, and an NFC tag.

3. The computer-implemented method in accordance with claim 2, wherein the link is exposed to the one or more other players via social media publication.

4. The computer-implemented method in accordance with claim 2, wherein the link is exposed to the one or more other players via a social media invitation.

5. The computer-implemented method in accordance with claim 1, wherein enabling, by at least one of the one or more processors, one or more other players to access the stored customized virtual wagering game comprises exposing the customized virtual wagering game as an icon in a virtual casino having a plurality of such icons.

6. The computer-implemented method in accordance with claim 1, wherein the customized virtual wagering game is a component of a virtual casino created by the first player, and wherein enabling, by at least one of the one or more processors, one or more other players to access the stored customized virtual wagering game comprises exposing the virtual casino to the one or more other players via an icon on a virtual board advertising multiple casinos.

7. The computer-implemented method in accordance with claim 1, wherein the customization interface permits the first player to earn a customization feature by playing a customized game created by another player.

8. The computer-implemented method in accordance with claim 1, wherein the customization interface permits the first player to earn a customization feature by playing multiple customized games created by multiple other players respectively.

9. The computer-implemented method in accordance with claim 1, further comprising providing a benefit to the first player based on play by the one or more other players of the customized virtual wagering game created by the first player.

10. The computer-implemented method in accordance with claim 9, wherein providing a benefit to the first player comprises providing virtual currency to the first player.

11. A non-transitory computer-readable medium having stored thereon computer-executable instructions for an operator to provide a customized virtual wagering game to a plurality of players comprising:
instructions for providing a base version of the customized virtual wagering game to a first player;
instructions for receiving an indication of one or more desired alterations to the base version of the customized virtual wagering game from the first player through a customization interface;
instructions for creating the customized virtual wagering game by altering the base version of the customized virtual wagering game in accordance with the one or more desired alterations;
instructions for storing the customized virtual wagering game; and
instructions for providing the customized virtual wagering game to players other than the first player to permit them to play the customized virtual wagering game.

12. The non-transitory computer-readable medium in accordance with claim 11, wherein the instructions for providing the customized virtual wagering game to players other than the first player comprise instructions for exposing the customized virtual wagering game as an icon in a virtual casino having a plurality of such icons.

13. The non-transitory computer-readable medium in accordance with claim 11, wherein the customized virtual wagering game is a component of a virtual casino created by the first player, and wherein the instructions for providing the customized virtual wagering game to players other than the first player comprise instructions for exposing the virtual casino via an icon on a virtual board advertising multiple casinos.

14. The non-transitory computer-readable medium in accordance with claim 11, wherein the instructions for providing the customized virtual wagering game to players other than the first player comprise instructions for providing access to the stored customized virtual wagering game via a link comprising at least one of a URL, a QR code, and an NFC tag.

15. The non-transitory computer-readable medium in accordance with claim 11, wherein the customization interface permits the first player to earn a customization feature by playing a customized virtual game created by another player.

16. The non-transitory computer-readable medium in accordance with claim 11, wherein the customization interface permits the first player to earn a customization feature by playing multiple customized games created by multiple other players respectively.

17. A system for an operator to provide a customized wagering game to a plurality of players comprising an operator server configured to provide a customization interface to a first player permitting the first player to create the customized wagering game, the operator server being further configured to store the customized wagering game and to provide the customized wagering game to a plurality of other players.

18. The system according to claim 17, wherein the operator server is configured to provide the customized wagering game to the plurality of other players via a link comprising at least one of a URL, a QR code, and a NFC tag.

19. The system according to claim 17, wherein the link is exposed to the plurality of other players via at least one of a social media publication and a social media invitation.

20. The system according to claim 17, wherein the operator server is further configured to provide a benefit to the first player based on play by the plurality of other players of the customized virtual wagering game created by the first player.
